(19) United States
(12) Patent Application Publication
(10) Pub. No.: US 2009/0228513 A1
(43) Pub. Date: Sep. 10, 2009

(54) METHODS, APPARATUSES, AND COMPUTER PROGRAM PRODUCTS FOR MODELING CONTACT NETWORKS

(75) Inventor: Jilei Tian, Tamere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 12/043,614

(22) Filed: Mar. 6, 2008

(51) Int. Cl. G06F 17/30

(52) U.S. Cl. 707/102; 707/E17.005

(57) ABSTRACT

An apparatus for modeling a contact network may include a processor. The processor may be configured to store a plurality of contacts lists, which collectively comprise a contact network. Each contacts list may be comprised of a plurality of contact entries and may be associated with a user of a remote device. The processor may further be configured to model the contact network using one or more modeling parameters. The processor may be configured to generate a plurality of suggested contact entries for a user based at least in part upon the one or more modeling parameters used to model the contact network. The suggested contact entries may be extracted from contact entries stored in the contacts network. Corresponding methods, systems, and computer program products are also provided.

### TECHNOLOGICAL FIELD

Embodiments of the present invention relate generally to mobile communication technology and, more particularly, relate to methods, apparatuses, computer program products, and systems for modeling contact networks and intelligently generating suggested contacts based on a modeled contact network.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Consequently, mobile communications devices have become an integral part of consumers' everyday lives and are used for both professional and personal communications and are capable of executing numerous functions. Personal information management constitutes one group of functions executed by mobile devices that are of particular importance to mobile device users. These personal information management functions include calendar and data management functions as well as contact storage. Contact storage is the most frequently used function, enabling expedited communication using a mobile device. With current contact storage technology, mobile devices are often limited to storing a static list of users' professional and personal contacts. However, current static contacts lists in mobile devices have several major drawbacks, the most critical of which is that static contact lists only provide a user with information that the user is already aware of and has previously manually stored in the memory of his mobile device. It would be desirable if current mobile device contact functionality were expanded to intelligently provide users with dynamic contact information that includes contact information of which the user was not previously aware.

Currently, if a mobile device user wishes to find contact information for potential contacts, the user can manually look up information, such as by using a web browser interface to find the information on an internet-based social network service. These computer-internet-based social networks are optimized for personal computer users with access to large displays and versatile input devices such as full-sized QWERTY keyboards and mouse devices. As such, standard internet-based social networks may not easily be used on mobile devices with smaller display screens and more limited input means.

Moreover, current internet-based social networks only share contact information with users in a more or less passive manner wherein users search the social network for information based upon keywords or other defined criteria. The internet-based social networks do not dynamically model the social network or actively and intelligently provide users with suggested information based upon a user's own personal information and contacts list. Therefore, the use of current internet-based social networks requires a user to spend a considerable amount of time searching and interacting with the social network, which may not be optimum for a mobile device user on the go having only a limited amount of time to interact with the device due to time constraints or limited battery life of the mobile device. Furthermore, a mobile device user billed by a wireless service provider based upon the amount of time spent using the device may incur significant monetary charges for internet access time spent searching an internet-based social network.

Accordingly, it may be advantageous to provide mobile device users with improved contact functionality, which may automatically and intelligently provide users with information about suggested contacts that may be of value to users on both a personal and professional level.

### BRIEF SUMMARY

A method, apparatus, and computer program product, are therefore provided to enable modeling of a contact network and generation of suggested contact entries for a user. In particular, a method, apparatus, and computer program product are provided to enable, for example, a user to receive suggested contact entries and in some embodiments to receive suggested contact entries in response to a user-defined query or set of criteria automatically learned from user via user history, preference and sensors. In this regard, a user is not limited to a set of contact information in his mobile device of which the user was already aware. Accordingly, user experience may be enhanced by enabling users to interact with suggested contacts generated using a model of a contacts network who may be helpful or of interest to the user.

In one exemplary embodiment, a method is provided which includes storing a plurality of contacts lists collectively comprising a contact network. Each contacts list may be comprised of a plurality of contact entries and may be associated with a user of a remote device. The method may further include modeling the contact network using one or more modeling parameters.

In some embodiments, the method may further include generating a plurality of suggested contact entries for a user based at least in part upon the one or more modeling parameters used to model the contact network. The suggested contact entries may be extracted from contact entries stored in the contact network. The method may additionally include sending the plurality of suggested contact entries to a remote device associated with the user.

In another exemplary embodiment, a computer program product is provided. The computer program product includes at least one computer-readable storage medium having computer-readable program code portions stored therein. The computer-readable program code portions include first and second executable portions. The first executable portion is for storing a plurality of contacts lists, which collectively comprise a contact network. Each contacts list may be comprised of a plurality of contact entries and may be associated with a user of a remote device. The second executable portion is for modeling the contact network using one or more modeling parameters.

In some embodiments, the computer-readable program code portions may further include third and fourth executable portions. The third executable portion is for generating a plurality of suggested contact entries for a user based at least in part upon the one or more modeling parameters used to model the contact network. The suggested contact entries may be extracted from contact entries stored in the contact network. The fourth executable portion is for sending the plurality of suggested contact entries to a remote device associated with the user.

In another exemplary embodiment, an apparatus including a processor is provided. The processor may be configured to store a plurality of contacts lists, which collectively comprise a contacts network. Each contacts list may be comprised of a plurality of contact entries and may be associated with a user of a remote device. The processor may further be configured to model the contacts network using one or more modeling parameters.

In some embodiments, the processor may additionally be configured to generate a plurality of suggested contact entries for a user based at least in part upon the one or more modeling parameters used to model the contact network. The suggested contact entries may be extracted from contact entries stored in the contact network and may be sent to a remote device associated with the user.

In another exemplary embodiment, a method is provided, which includes receiving a plurality of suggested contact entries extracted from a contact network. The plurality of suggested contact entries are generated by a remote computing device based at least in part upon one or more modeling parameters used to model the contact network. The method further comprises storing one or more of the plurality of suggested contact entries.

In another exemplary embodiment, an apparatus comprising a processor is provided. The processor may be configured to receive a plurality of suggested contact entries extracted from a contact network. The plurality of suggested contact entries are generated by a remote computing device based at least in part upon one or more modeling parameters used to model the contact network. The processor is further configured to store one or more of the plurality of suggested contact entries.

Embodiments of the invention may therefore provide a method, apparatus, and computer program product which may enhance user experience during mobile communications. As a result, for example, users may benefit from using mobile terminals and other electronic devices with improved ability to provide users with suggested contacts.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a system for modeling contacts networks according to an exemplary embodiment of the present invention;

FIG. 4 illustrates a block diagram of a contact network server according to an exemplary embodiment of the present invention;

FIG. 5 illustrates a structure of a stored contact in a contacts network according to an exemplary embodiment of the present invention;

FIG. 6 illustrates a contact grammar graph according to an exemplary embodiment of the present invention;

FIG. 7 is a flowchart according to an exemplary method for modeling a contacts network and providing suggested contact entries according to an exemplary embodiment of the present invention; and

FIG. 8 is a flowchart according to an exemplary method for providing suggested contact entries according to another exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

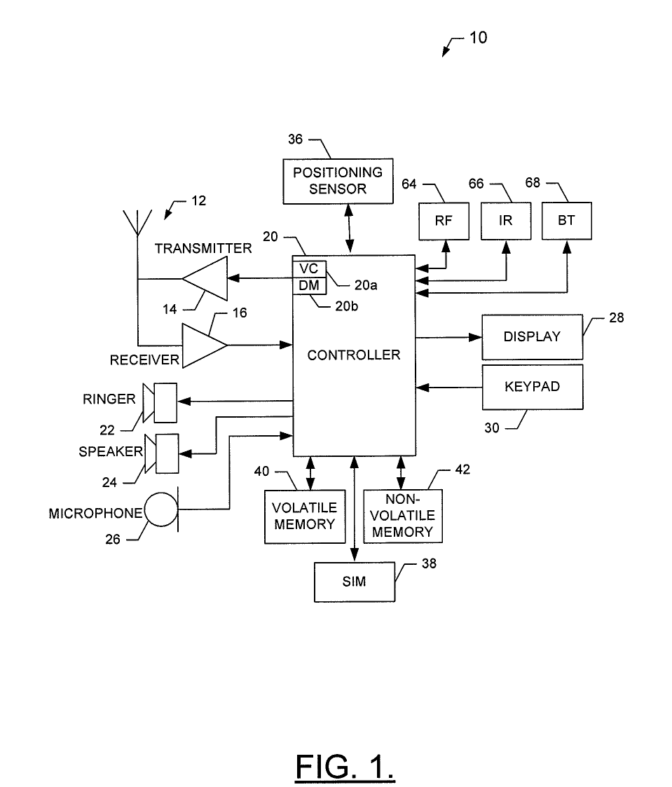

FIG. 1 illustrates a block diagram of a mobile terminal 10 that may benefit from the present invention. It should be understood, however, that the mobile terminal illustrated and hereinafter described is merely illustrative of one type of electronic device that may benefit from the present invention and, therefore, should not be taken to limit the scope of the present invention. While several embodiments of the electronic device are illustrated and will be hereinafter described for purposes of example, other types of electronic devices, such as portable digital assistants (PDAs), pagers, laptop computers, desktop computers, gaming devices, televisions, and other types of electronic systems, may employ the present invention.

As shown, the mobile terminal 10 may include an antenna 12 in communication with a transmitter 14 and a receiver 16. The mobile terminal may also include a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi) wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be capable of operating in accordance with 3G wireless communication protocols such as a UMTS network employing WCDMA radio access technology. Some NAMPS, as well as TACS, mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry required for implementing audio and logic functions of the mobile terminal 10. For example, the controller 20 may be a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50.

The mobile terminal 10 may also comprise a user interface including a conventional earphone or speaker 24, a ringer 22, a microphone 26, a display 28, a user input interface, and/or the like, which may be coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal 10 may comprise other non-volatile memory 42, which may be embedded and/or may be removable. The non-volatile memory 42 may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

The mobile terminal 10 may further include a positioning sensor 36. The positioning sensor 36 may include, for example, a global positioning system (GPS) sensor, an assisted global positioning system (Assisted-GPS) sensor, etc. In one embodiment, however, the positioning sensor includes a pedometer or inertial sensor. Further, the positioning sensor may determine the location of the mobile terminal based upon signal triangulation or other mechanisms. The positioning sensor is capable of determining a location of the mobile terminal, such as latitude and longitude coordinates of the mobile terminal or a position relative to a reference point such as a destination or a start point. Information from the positioning sensor may be communicated to a memory of the mobile terminal or to another memory device to be stored as a position history or location information. Furthermore, the memory of the mobile terminal may store instructions for determining cell id information. In this regard, the memory may store an application program for execution by the controller 20, which determines an identity of the current cell, i.e., cell id identity or cell id information, with which the mobile terminal is in communication. In conjunction with the positioning sensor, the cell id information may be used to more accurately determine a location of the mobile terminal.

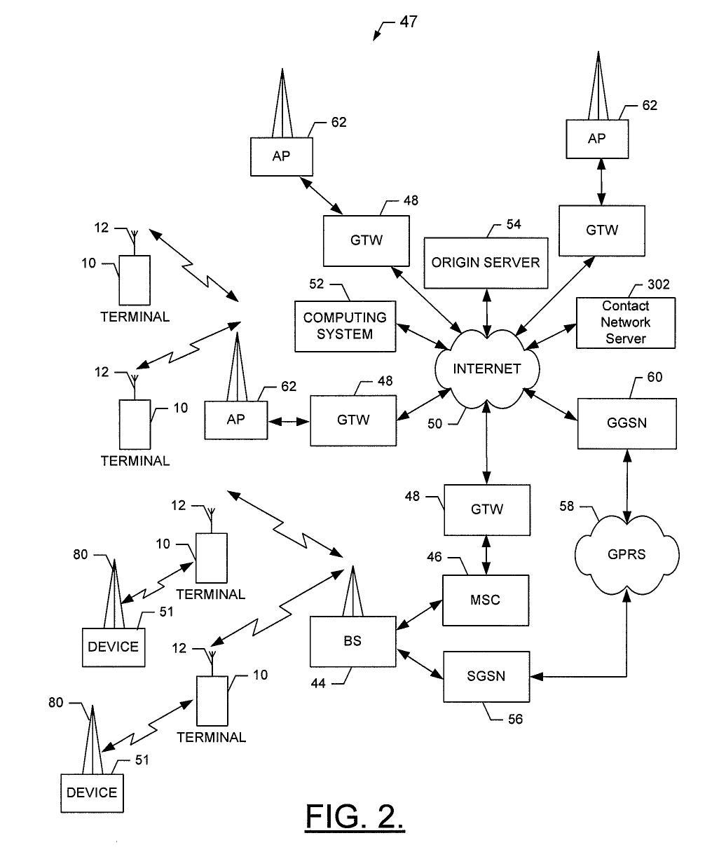

Referring now to FIG. 2, an illustration of one type of system that could support communications to and from an electronic device, such as the mobile terminal of FIG. 1, is provided by way of example, but not of limitation. As shown, one or more mobile terminals 10 may each include an antenna 112 for transmitting signals to and for receiving signals from a base site or base station (BS) 44. The base station 44 may be a part of one or more cellular or mobile networks each of which may comprise elements required to operate the network, such as a mobile switching center (MSC) 46. As well known to those skilled in the art, the mobile network may also be referred to as a Base Station/MSC/Interworking function (BMI). In operation, the MSC 46 may be capable of routing calls to and from the mobile terminal 10 when the mobile terminal 10 is making and receiving calls. The MSC 46 may also provide a connection to landline trunks when the mobile terminal 10 is involved in a call. In addition, the MSC 46 may be capable of controlling the forwarding of messages to and from the mobile terminal 10, and may also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 may be coupled to a data network, such as a local area network (LAN), a metropolitan area network (MAN), and/or a wide area network (WAN). The MSC 46 may be directly coupled to the data network. In one typical embodiment, however, the MSC 46 may be coupled to a GTW 48, and the GTW 48 may be coupled to a WAN, such as the Internet 50. In turn, devices such as processing elements (e.g., personal computers, server computers or the like) may be coupled to the mobile terminal 10 via the Internet 50. For example, as explained below, the processing elements may include one or more processing elements associated with a computing system 52 (one shown in FIG. 2), origin server 54 (one shown in FIG. 2) or the like, as described below.

As shown in FIG. 2, the BS 44 may also be coupled to a signaling GPRS (General Packet Radio Service) support node (SGSN) 56. As known to those skilled in the art, the SGSN 56 may be capable of performing functions similar to the MSC 46 for packet switched services. The SGSN 56, like the MSC 46, may be coupled to a data network, such as the Internet 50. The SGSN 56 may be directly coupled to the data network. Alternatively, the SGSN 56 may be coupled to a packet-switched core network, such as a GPRS core network 58. The packet-switched core network may then be coupled to another GTW 48, such as a GTW GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown in FIG. 2 and described herein, it should be appreciated that electronic devices, such as the mobile terminal 10, may be coupled to one or more of any of a number of different networks through the BS 44. In this regard, the network(s) may be capable of supporting communication in accordance with any one or more of a number of first-generation (1G), second-generation (2G), 2.5G, third-generation (3G), fourth generation (4G) and/or future mobile communication protocols or the like. For example, one or more of the network(s) may be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

As depicted in FIG. 2, the mobile terminal 10 may further be coupled to one or more wireless access points (APs) 62. The APs 62 may comprise access points configured to communicate with the mobile terminal 10 in accordance with techniques such as, for example, radio frequency (RF), Bluetooth™ (BT), infrared (IrDA) or any of a number of different wireless networking techniques, including wireless LAN (WLAN) techniques such as IEEE 802.11 (e.g., 802.11a, 802.11b, 802.11g, 802.11n, etc.), Wibree™ techniques, WiMAX techniques such as IEEE 802.16, Wireless-Fidelity (Wi-Fi) techniques and/or ultra wideband (UWB) techniques such as IEEE 802.15 or the like. The APs 62 may be coupled to the Internet 50. Like with the MSC 46, the APs 62 may be directly coupled to the Internet 50. In one embodiment, however, the APs 62 may be indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 and/or origin server 54 across the Internet 50, the mobile terminal 10, computing system 52 and origin server 54 may be coupled to one another and communicate in accordance with, for example, RF, BT, IrDA or any of a number of different wireline or wireless communication techniques, including LAN, WLAN, WiMAX, Wireless Fidelity (Wi-Fi), Wibree™ and/or UWB techniques. One or more of the computing systems 52 may additionally, or alternatively, include a removable memory capable of storing content, which can thereafter be transferred to the mobile terminal 10. Further, the mobile terminal 10 may be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, Wibree™, Wi-Fi, WLAN, WiMAX and/or UWB techniques. In this regard, the mobile terminal 10 may be capable of communicating with other devices via short-range communication techniques. For instance, the mobile terminal 10 may be in wireless short-range communication with one or more devices 51 that are equipped with a short-range communication transceiver 80. The electronic devices 51 can comprise any of a number of different devices and transponders capable of transmitting and/or receiving data in accordance with any of a number of different short-range communication techniques including but not limited to Bluetooth™, RFID, IR, WLAN, Infrared Data Association (IrDA) or the like. The electronic device 51 may include any of a number of different mobile or stationary devices, including other mobile terminals, wireless accessories, appliances, portable digital assistants (PDAs), pagers, laptop computers, motion sensors, light switches and other types of electronic devices.

The system of FIG. 2 may also include a contact network server 302. The contact network server 302, which will be described more fully in the ensuing paragraphs, may receive, store, and send or otherwise transmit contacts for a plurality of users of mobile terminals 10. As such, the contact network server 302 may communicate with a mobile terminal 10 to send and receive contacts over the system of FIG. 2. The contact network server may also receive contacts from other computing devices, such as the computing system 52, over a network, such as the Internet 50.

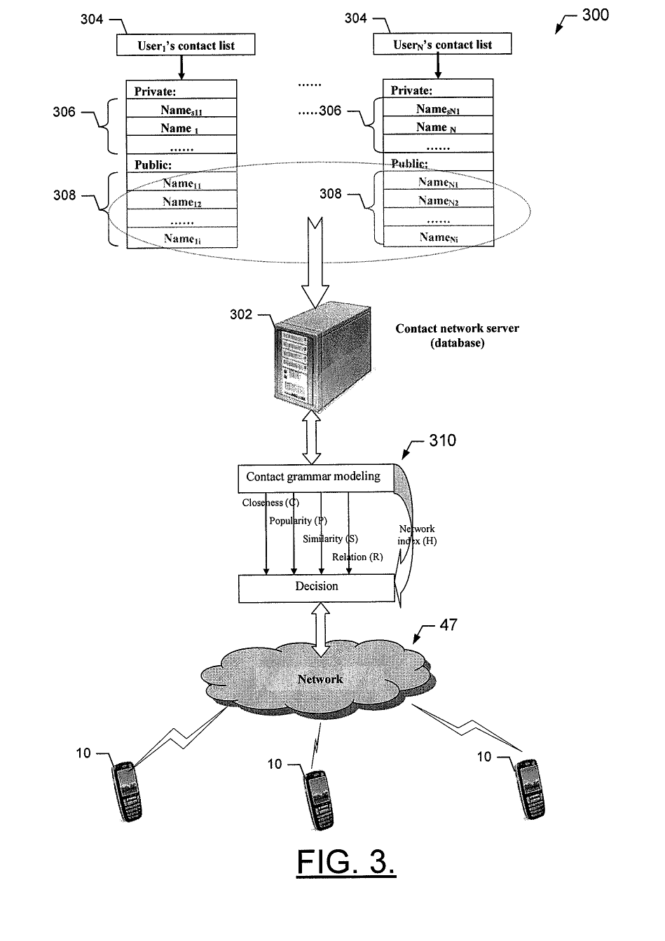

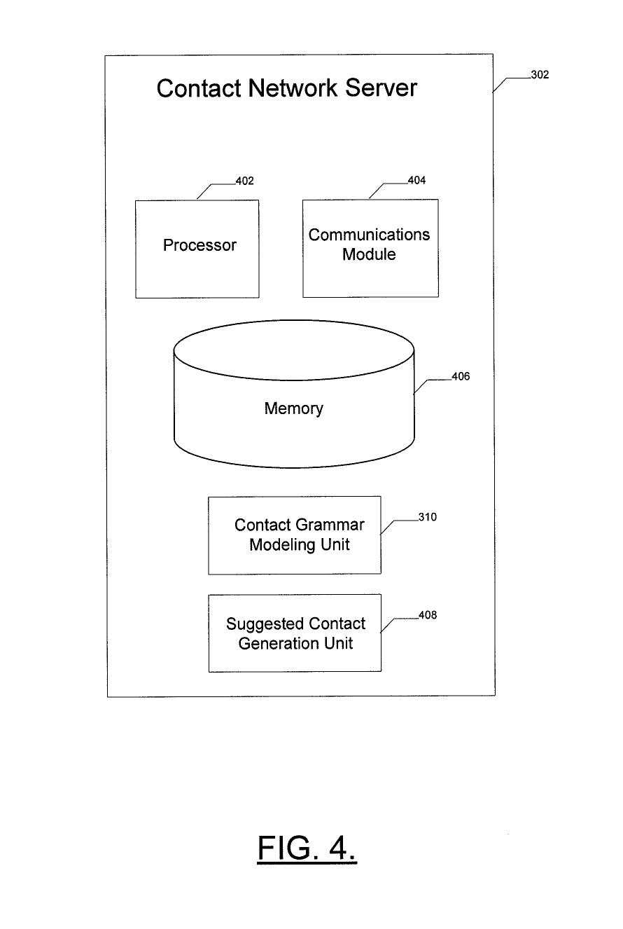

Referring now to FIG. 3, a basic diagram is depicted of a system 300 for modeling contact networks. The system may include a contact network server 302. Although referred to herein as a “server,” the contact network server 302 may be embodied as any computing device or plurality of computing devices configured to receive, store, and send contact entries and contacts lists 304. A block diagram of a contact network server 302 according to an exemplary embodiment of the invention is illustrated in FIG. 4. As used herein, “exemplary” merely refers to an example embodiment and should not be construed to mean a preferred or the only embodiment. As such, many embodiments are contemplated and enabled by the invention of the present application. The contact network server 302 may include a processor 402 to control the receiving, storing, and sending of contacts and contacts lists 304. Although described herein as a “processor,” it will be appreciated that the processor 402 may comprise multiple processors working together in parallel, which may be embodied on a single computing device or which may be embodied on multiple computing devices, such as a server cluster, which together execute the functionalities of the contact network server 302. The contact network server 302 may further include a memory 406 on which received contacts lists 304 may be stored, such as in a database of contacts. These stored contacts lists may comprise a “contacts network.” Although illustrated herein as being internal to the contact network server 302, the memory 406 may be embodied on a computing device external to the contact network server 302 or may be distributed among several computing devices. The contact network server 302 may further include a communications module 404, which may be controlled by the processor 402, to enable sending and receiving of contacts lists 304 by the contact network server 302. The communications module 404 may comprise one or more network interfaces, which may implement any of several commonly known networking protocols, to enable communication with remote computing devices, such as mobile terminals 10.

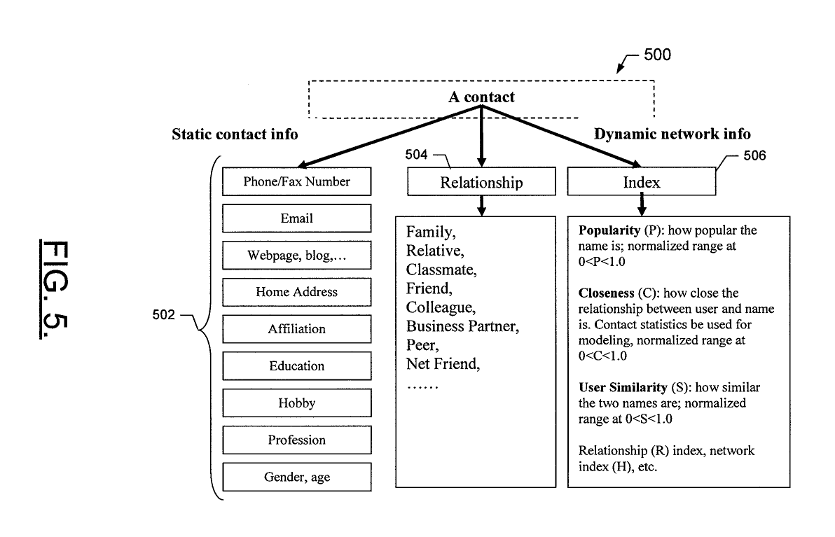

The structure of a contacts list 304 according to an exemplary embodiment of the invention is illustrated in FIG. 3. A user's contacts list 304 that may be received by the communications module 404 of the contact network server 302 may be comprised of a “private” portion 306 and a “public” portion 308. Both the private portion 306 and the public portion 308 of a contacts list 304 may include a plurality of names and contact information associated with each name that may be defined or otherwise entered by the user and referred to herein as a “contact entry.” Referring now to FIG. 5, one possible structure for a contact entry 500 stored in memory 406 according to an exemplary embodiment of the invention is illustrated. The contact entry 500 may include static contact information 502 and a relationship indicator 504, which may be defined by a user. For example, the static contact information 502 may comprise the contact's phone number(s), e-mail address(es), webpage URL(s), a home street address, business affiliation, business address, profession, educational level, educational institution(s) attended, hobbies, gender, and age. While in some embodiments the static contact information 502 may be entered for a contact entry 500 by a user creating the contact entry 500, in some embodiments the processor 402 may automatically fill in fields of the static contact information 502 by populating the fields with data about users of the system 300, which may be contained in a memory accessible by the system 300, such as in a network provider's subscriber database. The above several examples of static contact information 502 are provided merely for purposes of example and it will be appreciated that any number of demographic or other information about a contact may be stored in a contact entry 500. The relationship indicator 504 may be a description of how the user knows the contact, such as for example, a family member, classmate, business colleague, friend, etc.

Returning now to FIG. 3, a user may send a contacts list 304 to the contact network server 302 from a remote computing device, such as a mobile terminal 10 or from any other computing device capable of communicating with the contact network server 302 over a network, such as that of FIG. 2 and sending a contacts list 304 to the contact network server 302. The processor 402 may then store the received contacts list 304 in memory 406 in association with the user. If a contacts list 304 associated with the user is already stored in memory 406, then the processor 402 may overwrite the previously stored contacts list 304 or otherwise update the stored information with information that has changed in the most recently received contacts list 304. In alternative embodiments, the processor 402 of the contact network server 302 may be configured to request that a remote computing device, such as a mobile terminal 10, upload a contacts list 304 for a user periodically so that the processor 402 may automatically update a contacts list 304 stored in memory 406 in association with the user. Alternatively, the remote computing device, such as a mobile terminal 10, may be configured to periodically upload the contacts list 304 to the contact network server 302. These processes of updating contacts lists 304 stored in memory 406 to reflect changes to a remote contacts list 304 associated with the user according to various embodiments of the invention are referred to as “synchronization.”

In embodiments wherein contacts lists 304 are transmitted to the contact network server 302 from a remote computing device other than a mobile terminal 10, the processor 402 may further be configured to transmit via the communications module 404 the contacts lists 304 to a mobile terminal 10 associated with a user with whom each respective contacts list 304 is associated. This transmission may be performed in response to receipt of an updated contacts list 304 for the user or may be performed on a scheduled or otherwise routine basis. Additionally or alternatively, the processor 402 may send a user's contacts list 304 to a mobile terminal 10 associated with the user in response to a query or request by the mobile terminal 10. This query or request may be initiated manually by the user or may be performed on a scheduled basis and controlled by a processor such as the controller 20 of the mobile terminal 10. Upon receipt of the contacts list 304, the controller 20 of the mobile terminal 10 may be configured to store the received contacts list 304 in memory of the mobile terminal 10, such as non-volatile memory 42.

The processor 402 may further be configured to store frequency data in memory 406 in association with each contact entry 500 in a user's stored contacts list 304. This frequency data may represent a frequency with which the user communicates with each respective contact in his contacts list 304. It will be appreciated that various modes of communication may be taken into account, such as, for example, standard voice phone calls, text messages (SMS), multimedia messages (MMS), e-mails, or other communication services that may be carried out using a mobile terminal 10. In some embodiments, the frequency data may be a raw integer value, representing a number of times that the user has communicated with the contact. In other embodiments, the frequency data may represent a rate at which the user communicates with the contact, such as a certain number of communications over a unit of time. This frequency data may be obtained in a number of ways. In some embodiments, hardware embodied on or software executed by the controller 20 of the mobile terminal 10 may be configured to periodically upload recent communications with contacts stored in the contacts list 304 of the mobile terminal 10 to the contact network server 302. In alternative embodiments, a computing device of the system 47 of FIG. 2, perhaps the contact network server 302 itself, may be configured to monitor communications over the network so that frequency data stored in memory 406 may be appropriately updated.

The contact network server 302 may further comprise a contact grammar modeling unit 310, which may be configured to model the plurality of contact entries 500 comprising a contact network stored in memory 406. The contact grammar modeling unit 310 may be embodied as hardware or software, which may be embodied as or otherwise controlled by the processor 402 of the contact network server 302. The contact grammar modeling unit 310 may be configured to use a number of modeling parameters to model the contact network. These parameters may include, for example, closeness, popularity, similarity, and relation, which are illustrated in FIG. 3 and which will be described in more detail herein below.

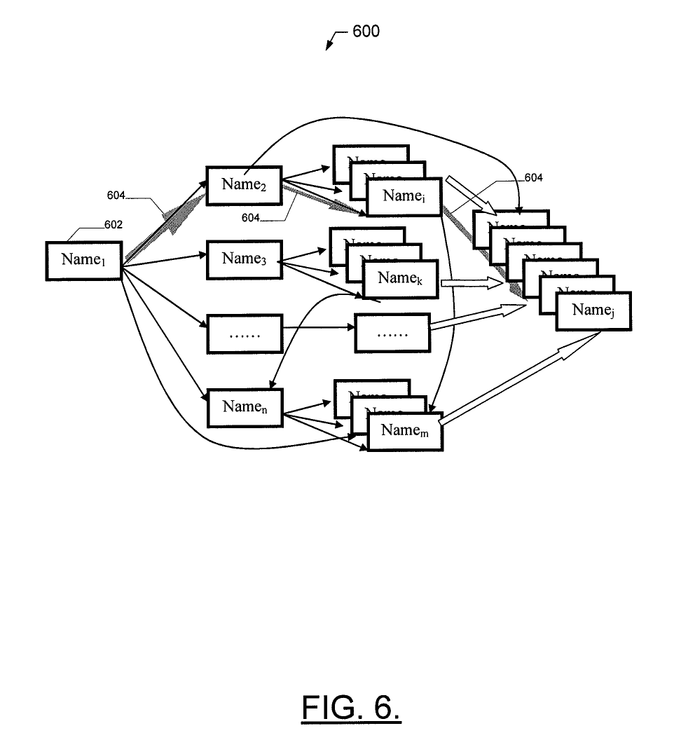

The model of the plurality of contact entries 500 may be used to generate a contact grammar, which may be illustrated as a grammar graph 600 as shown in FIG. 6. Each user name, i.e. a contact entry 500 may be represented as a node 602 in the grammar graph 600. According to an exemplary embodiment, in modeling the plurality of contact entries 500, the contact grammar modeling unit 310 may only model contact entries 500 that are stored in public portions 308 of the contacts lists 304. This modeling of only public portions 308 of contacts lists 304 is because the model of the contact network is used to generate suggested contact entries 500 for users of mobile terminals 10. As such, a user who uploads his contacts list 304 to the contact network server 302 may wish to maintain certain of his contact entries 500 “private” such that they will not be shared with other users of mobile terminals 10 using the system of FIG. 3. Therefore, according to an exemplary embodiment of the invention, a contact entry 500 that is listed in a user's private portion 306 of his contact list 304 may not be suggested to any other user unless another user has stored the same contact in the public portion 308 of a contact list 304.

The contact network server 302 may further comprise a suggested contact generation unit 408 to handle the generation of suggested contact entries 500 based upon the model of the contact network. The suggested contact generation unit 408 may be embodied as hardware or software, which may be embodied as or otherwise controlled by the processor 402 of the contact network server 302. The suggested contact generation unit 408 may suggest contact entries 500 using any of several methods, which will be discussed further herein below.

Closeness Index

The closeness index parameter, which may be computed by the contact grammar modeling unit 310, is a parameter used to quantitatively indicate the closeness between any two contact names in the contact grammar. For example, the closeness between a user (Name₁) and a person in the user's contacts list 304 (Name₂) may be modeled by the following probability formula:

$$C ( {Name}_{1} , {Name}_{2} ) = Prob ( {Name}_{2} \vert {Name}_{1} ) = \frac{\begin{matrix}Total counting that User < {Name}_{1} > \\ contacts to < {Name}_{2} >\end{matrix}}{Total contact counting of User < {Name}_{1} >}$$

In this regard, the closeness between Name₁ and Name₂ may be calculated by dividing the frequency with which Name₁ communicates with Name₂ by the frequency with which Name₁ communicates with all persons. As discussed previously, the frequency data necessary to perform this calculation may be stored in memory 406. Thus, for example, if Name₁ communicates with Name₂ 10 times in a week and communicates with all persons 100 times in that week, the closeness between Name1 and Name2 may be calculated as:

$$C ( {Name}_{1} , {Name}_{2} ) = Prob ( {Name}_{2} \vert {Name}_{1} ) = \frac{10}{100} = 0.1$$

This closeness calculation for each contact entry 500 in a user's contacts list 304 may be stored in each contact entry 500 in memory 406. Referring once again to FIG. 5, which illustrates the structure of a contact entry 500 according to an exemplary embodiment of the invention, a contact entry 500 may further comprise a dynamic network information index 506. This dynamic network information index 506 may be maintained and updated by hardware embodied on or software executed by the processor 402 of the contact network server 302. The dynamic network information index 506 may store values for all of the modeling parameters used to model the contact network which represent the relation between the user and the contact. Thus, the dynamic network information index 506 may store the closeness value calculated between a user and each contact entry 500 in his contacts list 304.

This closeness index parameter concept may be extended to the contact network at large so that the closeness between any name pair in the contact grammar may be calculated using a dynamic algorithm. As such, the contact grammar modeling unit 310 may be configured to dynamically calculate the closeness, otherwise referred to as the “best path”, between name pair <Nameᵢ> and <Nameⱼ> using an algorithm such as Viterbi or A* to find the path between the name pair that maximizes the total closeness along the path. The closeness between the name pair <Nameᵢ> and <Nameⱼ> is the normalized cumulative closeness along the best path, illustrated by the line arrows 604 in FIG. 6. Thus, assuming that the path from <Nameᵢ> to <Nameⱼ> goes through <Nameₚₐₜₕ₍ᵢ₎>, . . . , <Name_{path(N)}>, where I=path(1), j=path(N), and N=the number of contacts in the path, the path may be calculated as:

$${path}^{*} = {arg max}_{all path} C ( {Name}_{i} , {Name}_{j} \vert path )$$

$$C ( {Name}_{i} , {Name}_{j} \vert path ) = \frac{{\sum }_{k = i}^{N - 1} P ( {Name}_{path ( k + 1 )} \vert {Name}_{path ( k )} )}{N}$$

$$C ( {Name}_{i} , {Name}_{j} ) = C ( {Name}_{i} , {Name}_{j} \vert {path}^{*} )$$

This closeness index parameter is a dynamic parameter, which may be recalculated and updated with regularity by the contact grammar modeling unit 310 as contacts lists 304 of users of the network are updated. It is important to note that the best path is determined based in part upon frequency data and not just the number of nodes between a name pair. As such, consider two scenarios:
Scenario 1: Assume that John has Tom in his contacts list 304 and calls Tom once per week. Assume that Tom has Mary in his contacts list 304 and calls Mary once per week.
Scenario 2: Now, assume that John also has Bob in his contacts list 304 and calls Bob six times per week. Assume further that Bob has Richard in his contacts list 304 and calls Richard four times per week. Richard has Mary in his contacts list 304 and calls Mary twice per week.
   Thus, even though there are fewer nodes linking John and Mary in Scenario 1, Scenario 2 represents the best path, i.e. the path with the highest probability, due to the frequency of communications between the nodes of the path of Scenario 2.

Although a closeness index may be calculated as described above between each pair of individuals in the contact grammar in some embodiments, the regular performance of such calculations may be quite intensive with regard to taking up time and valuable cycles of the processor 402. Thus, in exemplary embodiments, a maximum threshold for the value of “N” may be set to define the neighborhood such that a closeness index may not be calculated for paths with more than N nodes.

The suggested contact generation unit 408 may use the calculated closeness index values to suggest contact entries 500 for users of the system 300. In this regard, the closeness index value represents a probability that two individuals may have a connection. For example, assume that John has Tom in his contacts list 304 and calls Tom ten times per week. Tom has Bob in his contacts list 304 and calls Bob twelve times per week. It is logical to assume that since John and Tom have interests in common and communicate often that John and Bob may have interests in common since Tom communicates frequently with Bob. Thus, based upon the resulting closeness index between John and Bob, the suggested contact generation unit 408 may suggest Bob as a contact entry 500 for Tom. Further, it will be appreciated that as a base calculation of closeness between two users in a path may include the frequency with which the first user communicates with a contact in his contacts list 304, the suggested contact generation unit 408 may be configured to generate suggested contact entries 500 for a user based at least in part upon the composition of a user's contacts list 304.

Popularity Index

The popularity index parameter is a parameter used to measure how popular a given person is, i.e. based upon users listing the person as a contact in their contacts list 304. In this regard, a “popular” person may be treated as a “trusted” person. This parameter may then be considered as a personal index in the network that may be used by the suggested contact generation unit 408 to generate suggested contact entries 500 for a user.

The contact grammar modeling unit 310 may be configured to determine popularity index values for users of the system 300 with the following equation:

$$P ( {Name}_{i} ) = ( 1 - d ) + d \cdot {\sum }_{k ∈ X ( {Name}_{i} )} P ( {Name}_{k} )$$

In this equation, P(Nameᵢ) represents the popularity index of <Nameᵢ>. d is a damping factor which may be a constant selected between 0 and 1. X(Nameᵢ) represents a set of users that all have <Nameᵢ> as a member of their contacts list 304. In this regard, the users may have <Nameᵢ> listed in either the private portion 306 or public portion 308 of their contacts list 304 for calculation of the popularity index.

The popularity index does not index the contact network as a whole, but may be determined by the contact grammar modeling unit 310 for each name in the contact grammar individually. The popularity index P for a first user is recursively defined by the popularity of those other users who include the first user in their contacts list 304. Thus, to calculate the popularity index of a user, the popularities of those names in X(Nameᵢ) are summed and the sum of the popularities is multiplied with the damping factor d. It will be appreciated that not only may the popularity index of a first user increase with the number of other users who list the first user in their contacts list 304, but also with increasing popularities of other users who are contacts of the first user. In this regard, if a second user who is a contact of a first user is popular the contact grammar modeling unit 310 may determine that the first user is more trusted as well because he is a contact of the second user and as such the popularity index of the first user may increase.

The contact grammar modeling unit 310 may store the calculated popularity index value of a user in the dynamic network information index 406 of all contact entries 500 in the contact grammar which list the user. The suggested contact generation unit 408 may then use popularity index values to generate suggested contact entries 500 for a user. In this regard, the suggested contact generation unit 408 may use popularity index values alone in determining suggested contact entries 500 or may use popularity index in combination with other modeling parameters, such as by using popularity index value as a “tie-breaker” to pare down suggested contact entries 500 in situations where the suggested contact generation unit 408 determines that two or more names are potential suggested contact entries based upon the values of one or more other modeling parameters.

Relationship Model

The relationship modeling parameter is a parameter used to model the relationship in a linked path between a first user, <Nameᵢ>, and another user in the first user's contact list, <Nameⱼ>. As discussed previously, a contact entry 500 may contain a relationship indicator 504 that may be defined by a user and that indicates the relationship between the user and the contact. The contact grammar modeling unit 310 may then use a plurality of relationship indicators 504 to model a relationship path between two users of the network 300. The contact grammar modeling unit 310 may generate a data structure such as a linked list or a tree to model the relationships between two or more users of the network 300.

The suggested contact generation unit 408 may then use the relationship model parameter to generate suggested contacts for a user. In this regard, the suggested contact generation unit 408 may determine suggested contact entries 500 based upon the path between two users in the relationship model. Assume, for example, that John has Julia in his contacts list 304 and the relationship indicator 504 of the contact entry 500 for Julia identifies that they are siblings. Julia then has Peter listed in her contacts list 304 but Peter is not listed in John's contacts list 304 and the relationship indicator 504 of the contact entry 500 for Peter identifies that he is Julia's child. The suggested contact generation unit 408 may then generate Peter as a suggested contact entry 500 for John based upon the familial relationship of uncle and nephew between the two.

In some embodiments, the suggested contact generation unit 408 may transmit to or otherwise provide for the display on a user's computing device, such as on a display 28 of a mobile terminal 10, of a data structure modeling the relationships between the user and one or more other suggested contact entries 500. The user may then indicate to the suggested contact generation unit 408 which, if any, of the suggested contact entries 500 he wishes to add to his contacts list 304. In some embodiments, a user may be presented with a tree or other data structure modeling the relationships between the user and a plurality of other users by the suggested contact generation unit 408 or the contact grammar modeling unit 310, which may solicit feedback on whether the relationship model is correct for the user. For example, in the above example of the familial relationship John, Julia, and Peter, the suggested contact generation unit 408 may determine that Peter is John's nephew. However, Peter may be Julia's adopted son or stepson and thus Peter may be afforded the opportunity to correct the automatic determination of the suggested contact generation unit 408 when presented with a relationship model.

User Similarity Index

The similarity index parameter S(Nameᵢ, Nameⱼ) is a parameter that may be used by the contact grammar modeling unit 310 to model the similarity between any user pair <Nameᵢ> and <Nameⱼ>. The logic behind the similarity index parameter is that similar users exhibit similar behavior, interests, and needs. Accordingly, the contact grammar modeling unit 310 may have access to various demographic information about users of the system 300. The contact grammar modeling unit 310 may be configured to access demographic information from various sources, such as from static contact information 502 of contact entries 500 as well as from a network provider's subscriber database or other databases containing information about users of the system 300. As such, the contact grammar modeling unit 310 may be configured to describe each user of the system 300 using a user property vector. The user property vector may contain indications of several properties describing a user, such as for example, gender, age, education, cognitive style, cultural background, personality factor, aptitude, hobby, nationality, income, social relationship, etc. The contact grammar modeling unit 310 may be further configured to extrapolate certain of these indications which are not pre-stored in databases accessible by the grammar modeling unit 310 from other stored indications or data describing a user of the system of 300.

Each user may then be described using the user property vector:

H(u)={F₁(u), F₂(u), . . . ,F_{N}(u)}

The user similarity index S(u,v) between users u and v may be calculated by the contact grammar modeling unit 310 as follows:

$$\begin{matrix}S ( u , v ) = ‖ H ( u ) - H ( v ) ‖ \\ = \frac{{\sum }_{n = 1}^{N} ( {F}_{n} ( u ) - E [ {F}_{n} ( u ) ] ) \cdot ( {F}_{n} ( v ) - E [ {F}_{n} ( v ) ] )}{\sqrt{{\sum }_{n = 1}^{N} {( {F}_{n} ( u ) - E [ {F}_{n} ( u ) ] )}^{2} \cdot {\sum }_{n = 1}^{N} ( {F}_{n} ( v ) - E [ {F}_{n} ( v ) ] )}}\end{matrix}$$

The contact grammar modeling unit 310 may store calculated user similarity index values in the dynamic network information index 506 of contact entries 500. The suggested contact generation unit 408 may then be configured to generate suggested contact entries 500 for a user based upon the user similarity index values calculated by the contact grammar modeling unit 310. In this regard, the contact grammar modeling unit 310 may suggest contact entries 500 for a user having the greatest similarity to the user.

Network Index

Although not a modeling parameter used by the suggested contact generation unit 408 to directly generate suggested contact entries 500, the network index parameter may provide the suggested contact generation unit 408 with valuable information about the state of the contact grammar of the contact network. The network index parameter, which may be calculated by the contact grammar modeling unit 310, may be used as a metric to measure the entropy or perplexity representative of how much information the contact grammar has. One possible representation of a value of the network index parameter according to an exemplary embodiment of the invention is the entropy H of the contact grammar, which may be calculated as:

$$H = \frac{1}{{V}^{2}} \cdot {\sum }_{i = 1}^{V} {\sum }_{j = 1}^{V} prob ( {Name}_{i} , {Name}_{j} ) \cdot log ( prob ( {Name}_{i} , {Name}_{j} ) )$$

The value of the network modeling parameter may be used by the suggested contact generation unit 408 to dynamically monitor the contact network. If the entropy value measured by the network index parameter indicates that there is relatively little information contained in the grammar, such as when a system 300 is first implemented, the suggested contact generation unit 408 may be configured not to suggest contact entries 500 to users or to suggest fewer contact entries 500 for a user than it may otherwise suggest. In this regard, the suggested contact generation unit 408 may be configured to generate suggested contact entries 500 under different guidelines or settings depending on whether the value of the network index parameter is above or below one or more predetermined threshold values.

As discussed, the suggested contact generation unit 408 may be configured to generate suggested contact entries 500 for users of the system 300 based upon the values of the modeling parameters determined by the contact grammar modeling unit 310. The suggested contact generation unit 408 may combine these modeling parameters to generate the suggested contact entries 500 by predicting a user's needs. The suggested contact generation unit 408 may make this determination in several ways, such as for example, by using linear decision, through the use of a regression tree (CART tree), through the use of rule-based logic, through a neural network, or through a Bayesian network.

The suggested contact generation unit 408 may transmit suggested contact entries 500 to a remote device, such as a mobile terminal 10, associated with a user via the communications module 404 of the contact network server 302. As such, the controller 20 of the mobile terminal 10 may be configured to store received suggested contact entries 500 in a memory of the mobile terminal 10, such as non-volatile memory 42. These suggested contact entries 500 may be transmitted individually or a plurality of suggested contact entries 500 may be transmitted together, such as in a contacts list 304. In this regard, a user's contacts list 304 may comprise a suggested contacts portion (not illustrated in FIG. 3) in addition to the private portion 306 and public portion 308. If a user communicates with a suggested contact entry 500 stored in his mobile terminal 10 and develops a personal, business, or other relationship with that contact, the user may move the contact entry 500 from the suggested contacts portion of his contacts list 300 to either the private portion 306 or public portion 308 of his contacts list 300.

The generation of suggested contact entries 500 by the suggested contact generation unit 408 may be unsupervised or supervised. In this regard, the suggested contact generation unit 408 may automatically generate a plurality of suggested contact entries 500 for a user and transmit them to a device associated with the user without receiving any query criteria or other input from the user. Alternatively, in some embodiments, the generation of suggested contact entries 500 may be supervised by a user. The suggested contact generation unit 408 may generate a plurality of suggested contact entries 500 and transmit them to the user device and a user may then provide feedback on the suggested contact entries 500 or otherwise select among the plurality of suggested contact entries 500 he wishes to store in his contacts list 304. In this regard, the suggested contact generation unit 408 may be configured to extrapolate user preferences from the user-provided feedback that may be used in the future by the suggested contact generation unit 408 when generating suggested contact entries 500.

Additionally or alternatively, a user may specify certain criteria prior to the generation of suggested contact entries 500 by the suggested contact generation unit 408 or a user may specifically query the suggested contact generation unit 408 for a suggested contact entry 500 satisfying certain criteria. For example, suppose John is a user of the system 300 and lives in California. John may travel to New York City with his mobile terminal 10 and desires someone to show him around the city. John may query the suggested contact generation unit 408 for a suggested contact entry 500 residing in the New York City area. The suggested contact generation unit 408 may generate one or more suggested contact entries 500 for John, such as based upon any of the modeling parameters previously discussed.

In some embodiments, the suggested contact generation unit 408 may automatically generate new suggested contact entries 500 based upon a change in a user's circumstance, such as a change in location as in the above example. In this regard, a mobile terminal 10 may ascertain its current location using the positioning sensor 36. This location may be transmitted to the contact network server 302 via the communications module 404. The suggested contact generation unit 408 may be configured to generate a new or additional plurality of suggested contact entries 500 in response to a change in a user's location. In the above example, the suggested contact generation unit 408 may generate a plurality of suggested contact entries 500 residing in the New York City area in response to John's travel from California to New York City. Additionally, or alternatively, one or both of the suggested contact generation unit 408 or the controller 20 of the mobile terminal 10 may be configured to reorder the presentation contact entries 500 in the suggested contacts portion of a user's contacts list 304 in response to a change in location. For example, any suggested contacts in John's contacts list 304 residing in New York City may be displayed first in his contacts list in response to his travel to New York City.

In a further example of the generation of a suggested contact entry 500 in response to a specific user request or query, John may be shopping in a music store and find an album that he thinks he might be interested in purchasing. John may then query the suggested contact generation unit 406 for a suggested contact entry 500 that is similar to him and may be able to give him an opinion on the album. The suggested contact generation unit 406 may then generate a suggested contact entry 500, such as based upon the user similarity index parameter and transmit the suggested contact entry 500 to John's mobile terminal 10.

In some embodiments, some or even most of the querying may be handled by the mobile terminal 10, itself. For example, the controller 20 may be configured to execute a query engine which may receive one or more search parameters from a user and transmit those to the suggested contact generation unit 408. A user may interact with the query engine, for example, through the display 28 and keypad 30 of the mobile terminal 10. Additionally or alternatively, the query engine may be configured to search through a user's contacts list 304 stored in non-volatile memory 42 of the mobile terminal 10 for a contact entry 500 fitting the user's search parameters. In this regard, a user may search among suggested contact entries 500 that were previously generated by the suggested contact generation unit 408 and transmitted to the suggested contacts portion of his contacts list 304 without requiring the suggested contact generation unit 408 to generate further suggested contact entries 500 based upon the query.

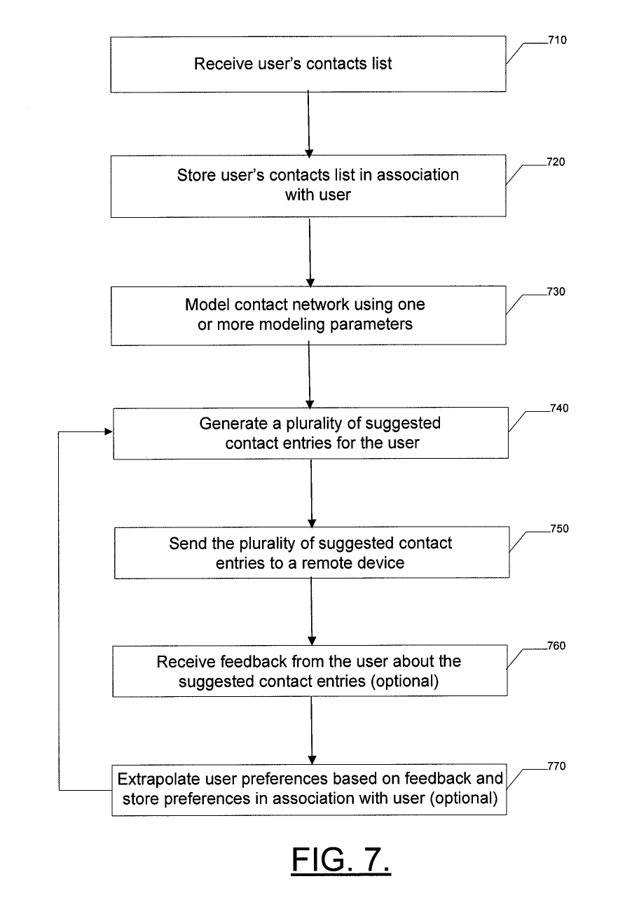

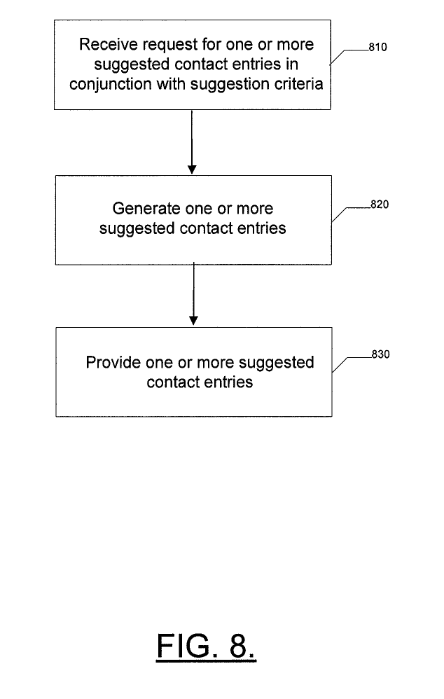

FIGS. 7 and 8 are flowcharts of a system, method, and computer program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for modeling a contact network and providing suggested contact entries as illustrated in FIG. 7 may include receiving a user's contacts list at operation 710. Operation 720 may comprise storing the user's contacts list in association with the user, such as in memory 406 of the contact network server 302. Next, at operation 730, the contact grammar modeling unit 310 may model the contact network using one or more modeling parameters. The suggested contact generation unit may then generate a plurality of suggested contact entries for the user at operation 740 and send the plurality of suggested contact entries to a remote device at operation 750. The suggested contact generation unit 408 may then optionally receive feedback from the user about the suggested contact entries at operation 760. The suggested contact generation unit 408 may then optionally extrapolate user preferences based upon the feedback and store the extrapolated preferences, such as in memory 406, in association with the user at operation 770. The method may then optionally return to operation 740 wherein the suggested contact generation unit 408 may generate further suggested contact entries for the user based upon the received feedback and/or the extrapolated user preferences.

One embodiment of a method for providing suggested contact entries as illustrated in FIG. 8 may include the suggested contact generation unit 408 receiving a request for one or more suggested contact entries in conjunction with suggestion criteria at operation 810. The suggested contact generation unit 408 may then generate one or more suggested contact entries at operation 820. Operation 830 may comprise the suggested contact generation unit 408 providing the one or more suggested contact entries to a remote device.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, at least some embodiments of the invention may provide several advantages to a user of a mobile terminal. For example, a user of a mobile terminal may not be limited to having only contact entries whose information the user is previously aware of in the user's contacts list. In that regard, a user may be dynamically provided with suggested contacts by a system that models a contact network storing contacts of a plurality of users. As such, the user may receive suggested contacts based upon one or more modeling parameters, based upon the user's existing contacts list, based upon user preferences, based upon query criteria, as well as based upon dynamic changes in circumstances, such as a change in location. These suggested contacts may provide the user with valuable help on certain matters and the user may develop meaningful personal or business relationships with the suggested contacts.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
storing a plurality of contacts lists, which collectively comprise a contact network, wherein each contacts list is comprised of a plurality of contact entries and is associated with a user of a remote device; and
modeling the contact network using one or more modeling parameters.

2. A method according to claim 1, wherein the one or more modeling parameters comprise a closeness index, a popularity index, a relationship model, or a user similarity index.

3. A method according to claim 1, further comprising:
generating a plurality of suggested contact entries for a user based at least in part upon the one or more modeling parameters used to model the contact network, wherein the plurality of suggested contact entries are extracted from contact entries stored in the contact network; and
sending the plurality of suggested contact entries to a remote device associated with the user.

4. A method according to claim 3, wherein the plurality of contacts lists are comprised of a plurality of contact entries listed in a public portion and a plurality of contact entries listed in a private portion, the contact network comprising a plurality of public contact entries and a plurality of private contact entries, and wherein the plurality of suggested contact entries are extracted only from the plurality of public contact entries stored in the contact network.

5. A method according to claim 3, further comprising storing data describing personal properties of a user associated with each of the received contacts lists, and wherein generating a plurality of suggested contact entries for a user further comprises generating a plurality of suggested contact entries for the user based upon the data describing personal properties of the user.

6. A method according to claim 3, further comprising:
storing a data value denoting a frequency with which a user communicates with a contact in association with one or more contact entries in the user's contacts list and wherein generating a plurality of suggested contact entries for a user further comprises generating a plurality of suggested contact entries for the user based upon the frequency data values.

7. A method according to claim 3, further comprising:
receiving feedback from the user about the plurality of suggested contact entries;
extrapolating one or more user preferences based upon the feedback; and
wherein generating a plurality of suggested contact entries further comprises generating a plurality of suggested contact entries for the user based upon the one or more extrapolated user preferences.

8. A method according to claim 1, wherein each contact entry in the contact network is comprised of personal contact information, personal properties, or dynamic network information indicating values of one or more network modeling parameters.

9. A computer program product comprising at least one computer-readable storage medium having computer-readable program code portions stored therein, the computer-readable program code portions comprising:
a first executable portion for storing a plurality of contacts lists, which collectively comprise a contact network, wherein each contacts list is comprised of a plurality of contact entries and is associated with a user of a remote device; and
a second executable portion for modeling the contact network using one or more modeling parameters.

10. A computer program product according to claim 9, wherein the one or more modeling parameters comprise a closeness index, a popularity index, a relationship model, or a user similarity index.

11. A computer program product according to claim 9, further comprising:
a third executable portion for generating a plurality of suggested contact entries for a user based at least in part upon the one or more modeling parameters used to model the contact network, wherein the plurality of suggested contact entries are extracted from contact entries stored in the contact network; and
a fourth executable portion for sending the plurality of suggested contact entries to a remote device associated with the user.

12. A computer program product according to claim 11, wherein the plurality of contacts lists are comprised of a plurality of contact entries listed in a public portion and a plurality of contact entries listed in a private portion, the contact network comprising a plurality of public contact entries and a plurality of private contact entries, and wherein the plurality of suggested contact entries are extracted only from the plurality of public contact entries stored in the contact network.

13. A computer program product according to claim 11, wherein the first executable portion includes instructions for storing data describing personal properties of the user associated with each of the received contacts lists, and wherein the third executable portion includes instructions for generating a plurality of suggested contact entries for the user based upon the data describing personal properties of the user.

14. A computer program product according to claim 11, wherein the first executable portion includes instructions for storing a data value denoting a frequency with which a user communicates with a contact in association with one or more contact entries in the user's contacts list, and wherein the third executable portion includes instructions for generating a plurality of suggested contact entries for the user based upon the frequency data values.

15. A computer program product according to claim 11, further comprising:
a fifth executable portion for receiving feedback from the user about the plurality of suggested contact entries;
a sixth executable portion for extrapolating one or more user preferences based upon the feedback; and
wherein the third executable portion includes instructions for generating a plurality of suggested contact entries for the user based upon the one or more extrapolated user preferences.

16. An apparatus comprising a processor configured to:
store a plurality of contacts lists, which collectively comprise a contact network, wherein each contacts list is comprised of a plurality of contact entries and is associated with a user of a remote device; and
model the contact network using one or more modeling parameters.

17. An apparatus according to claim 16, wherein the processor is further configured to model the contact network based upon one or more of a closeness index, a popularity index, a relationship model, or a user similarity index.

18. An apparatus according to claim 16, wherein the processor is further configured to:
generate a plurality of suggested contact entries for a user based at least in part upon the one or more modeling parameters used to model the contact network, wherein the plurality of suggested contact entries are extracted from contact entries stored in the contact network; and
send the plurality of suggested contact entries to a remote device associated with the user.

19. An apparatus according to claim 18, wherein the plurality of contacts lists are comprised of a plurality of contact entries listed in a public portion and a plurality of contact entries listed in a private portion, the contact network comprising a plurality of public contact entries and a plurality of private contact entries, and wherein the plurality of suggested contact entries are extracted only from the plurality of public contact entries stored in the contact network.

20. An apparatus according to claim 18, wherein the processor is further configured to:
store data describing personal properties of the user associated with each of the received contacts lists; and
generate a plurality of suggested contact entries for the user based upon the data describing personal properties of the user.

21. An apparatus according to claim 18, wherein the processor is further configured to:
store a data value denoting a frequency with which a user communicates with a contact in association with one or more contact entries in the user's contacts list; and
generate a plurality of suggested contact entries for the user based upon the frequency data values.

22. An apparatus according to claim 18, wherein the processor is further configured to:
receive feedback from the user about the plurality of suggested contact entries;
extrapolate one or more user preferences based upon the feedback; and
generate a plurality of suggested contact entries based upon the one or more extrapolated user preferences.

23. An apparatus according to claim 18, wherein each contact entry in the contact network is comprised of personal contact information, personal properties, or dynamic network information indicating values of one or more network modeling parameters.

24. A method comprising:
receiving a plurality of suggested contact entries extracted from a contact network, wherein the plurality of suggested contact entries are generated by a remote computing device based at least in part upon one or more modeling parameters used to model the contact network; and
storing one or more of the plurality of suggested contact entries.

25. An apparatus comprising a processor configured to:
receive a plurality of suggested contact entries extracted from a contact network, wherein the plurality of suggested contact entries are generated by a remote computing device based at least in part upon one or more modeling parameters used to model the contact network; and
store one or more of the plurality of suggested contact entries.
